(19) United States
(12) Patent Application Publication
(10) Pub. No.: US 2005/0269903 A1
(43) Pub. Date: Dec. 8, 2005

(54) Single-phase electroactive motor

(76) Inventors: Marc Rene Christian Budinger, Toulouse (FR); Jean-Francois Roland Rouchon, Muret (FR); Bertrand Nogarede, Toulouse (FR)

Correspondence Address: YOUNG & THOMPSON, 745 SOUTH 23RD STREET, 2ND FLOOR, ARLINGTON, VA, 22202, US

(21) Appl. No.: 10/525,760

(22) PCT Filed: Aug. 21, 2003
(86) PCT No.: PCT/FR03/02556

§ 371 Date: Jul. 19, 2005

(30) Foreign Application Priority Data
Aug. 30, 2002 (FR) 02/10755

(51) Int. Cl. H02N 2/00

(52) U.S. Cl. 310/323.01

(57) ABSTRACT

A rotary piezoelectric motor (1) in which a geometrical asymmetry can be introduced, e.g. in the counter-masses (11, 14) or in the stator fixing elements (10), in order to produce a phase shift previously obtained using a phase quadrature power supply. A simplified single-phase power supply (40) can be used with one such motor. The inventive motors offer advantages in terms of cost and reliability, particularly for motors that require only a single direction of rotation. The motors are particularly suitable for small motors such as those used for clock and watch making, microsurgery or microelectronics.

This invention relates to an electroactive rotary motor and a method of operation of such motor.

Electroactive motors use the capabilities of certain materials, in particular piezoelectric materials, to deform under the influence of an electric field passing through them.

Electroactive motors allow for precise movements, for example for step-by-step controls, and even when stopped retain significant specific torque. They therefore provide a favourable solution for positioning applications, particularly in fields such as lenses for optical appliances, the automotive industry (windscreen wipers, adjustable seats, etc.) or aviation controls.

Piezoelectric motors use piezoelectric materials as electroactive materials. The most recent and highest performance piezoelectric motors are annular or cylindrical travelling wave motors. Reference can be made for example to patent EP 0 538 791 (Canon), which describes a cylindrical motor of this type. To create the travelling wave on a surface of the piezoelectric motor, a two-phase power supply is used to generate a rotating electric field in the material. The material deforms under the influence of the field in such a way that it forms a ripple on the surface that directly or indirectly makes a rotor move.

However, these motors require a two-phase power supply that comprises a large number of active or passive electric components.

The object of the invention is to propose an electroactive motor with a simplified power supply, in order to propose a high-performance, rugged and cheap motor-power supply assembly.

According to a first aspect of the invention, such a motor comprises a stator fixed to the frame of the motor and designed to bend perpendicular to a principal direction, said stator comprising electroactive components stacked in the said principal direction, for example piezoelectric ceramics, surrounded by two counter-weights, characterised in that said stator has geometric dissymmetry in order to create resonance dissymmetry. This dissymmetry is known as geometric as opposed to electric dissymmetry in a power supply using two quadrature voltages. It allows for two bending modes to be obtained for the stator in two separate directions, preferably orthogonal to each other, perpendicular to the principal direction, and the resonance frequencies of which are different.

This geometric dissymmetry can be obtained by means of a dissymmetrical method of fixing the stator to the frame or by a dissymmetrical shape of the stator, and particularly a dissymmetrical shape for the counter-weights.

According to a second aspect of the invention, a method for supplying power to a mode rotation piezoelectric motor comprising a stator fixed to a frame of the motor and designed to bend perpendicular to a principal direction, said stator comprising piezoelectric ceramics stacked in the said principal direction surrounded by two counter-weights, said stator having geometric dissymmetry in order to create resonance dissymmetry, is characterised in that a single-phase power supply is used. Resonance frequencies will be selected for the power supply that are sufficiently close so that at the intermediate frequency, the amplitude of bending in each of the bending modes is appropriate to the operation of the motor. The intermediate frequency will more particularly be selected so that the phase difference between the two bending modes is 90°.

For a stator comprising two ceramics, one of the two terminals of the single-phase power supply will be connected to an interface between the two ceramics and the other terminal will be connected to surfaces of the ceramics respectively opposite the interface.

Other specific features and advantages of the invention will become apparent from the description below, which relates to non-limitative examples.

In the appended drawings:

FIG. 1 is a view of a first embodiment of a motor according to the invention;

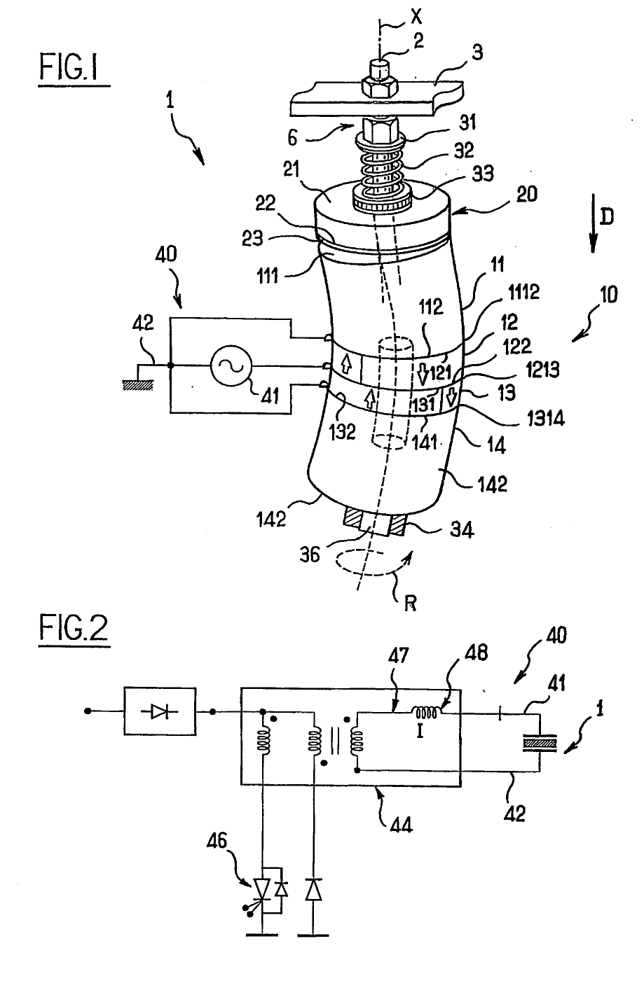

FIG. 2 is a diagram of a first possible type of single-phase power supply for a motor according to the invention, and in particular for the motor in FIG. 1;

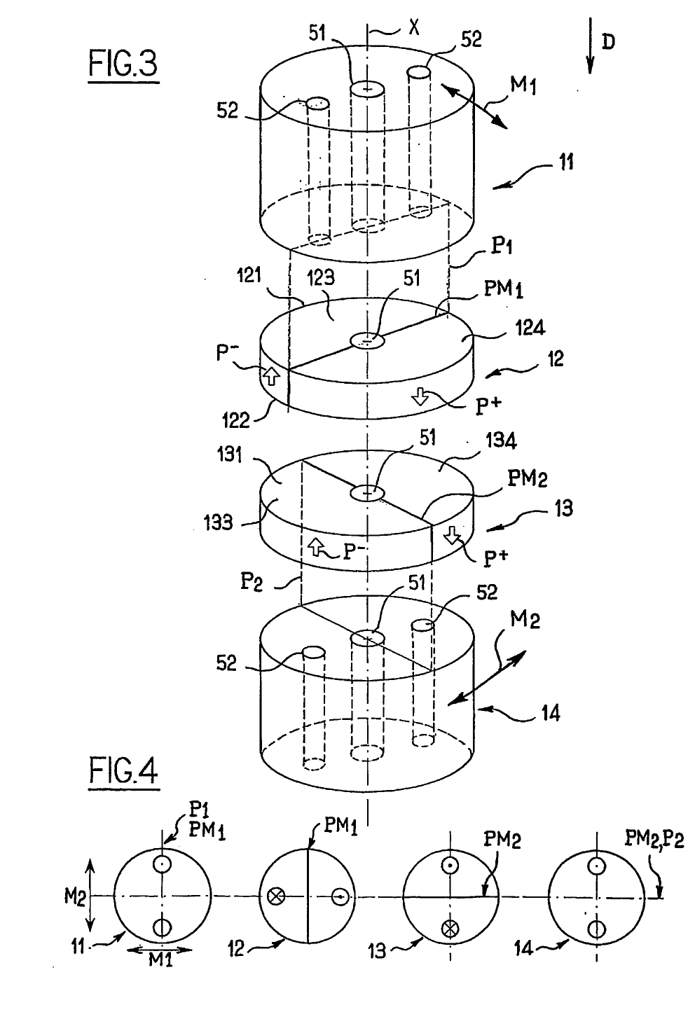

FIG. 3 is an exploded perspective view of the wafers and counter-weights forming a stator for the motor in FIG. 1;

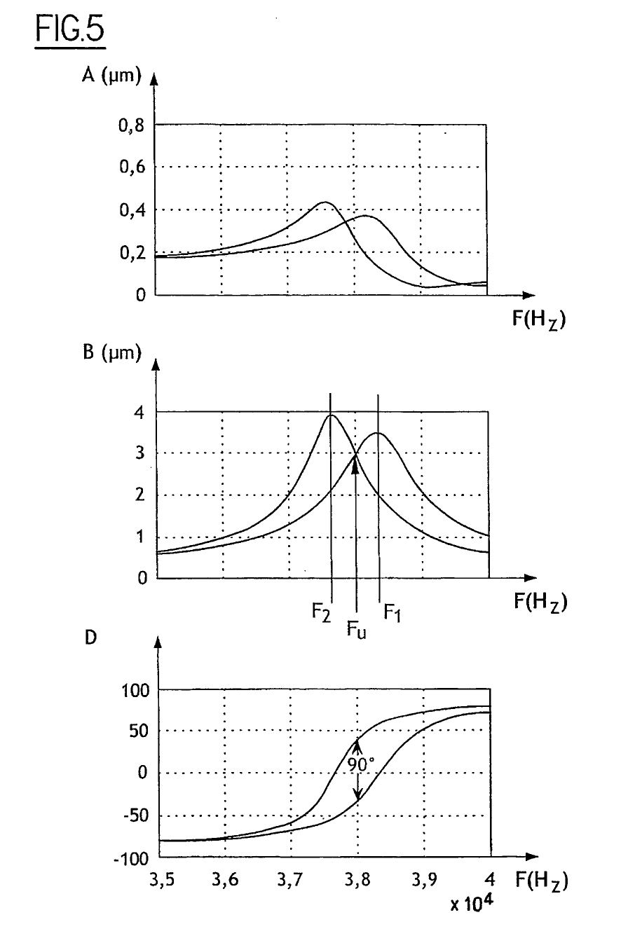

FIG. 4 is a plan view of the wafers and counter-weights of the motor in FIG. 1;

FIG. 5 is an illustration of characteristic curves of the motor in FIG. 1 as a function of the power supply frequency of the motor;

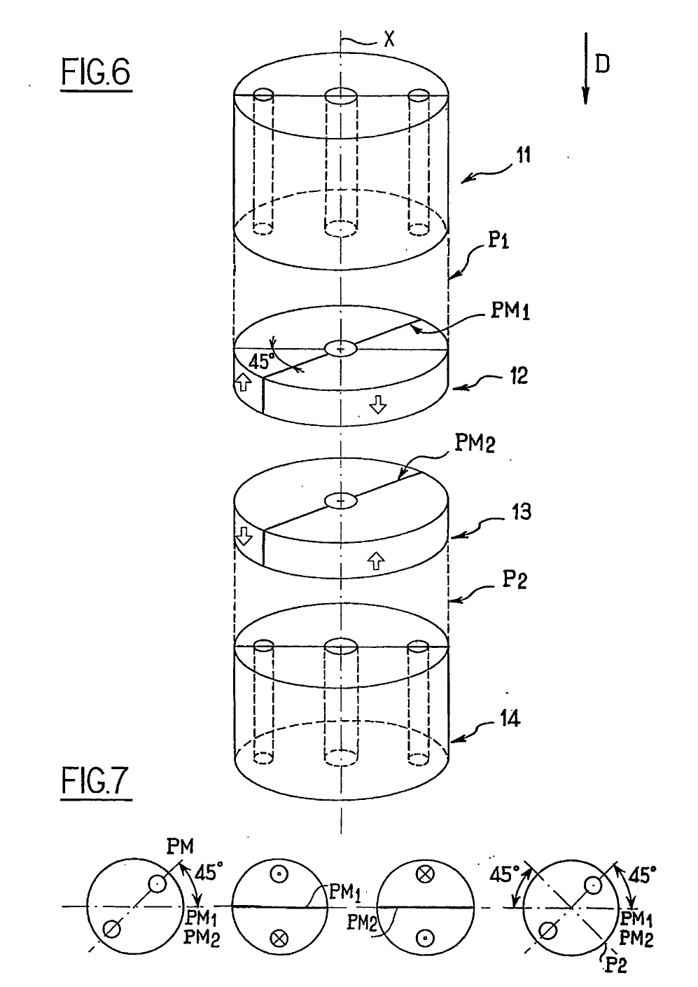

FIG. 6 is an exploded perspective view of the wafers and counter-weights forming a stator for a second embodiment of a motor according to the invention;

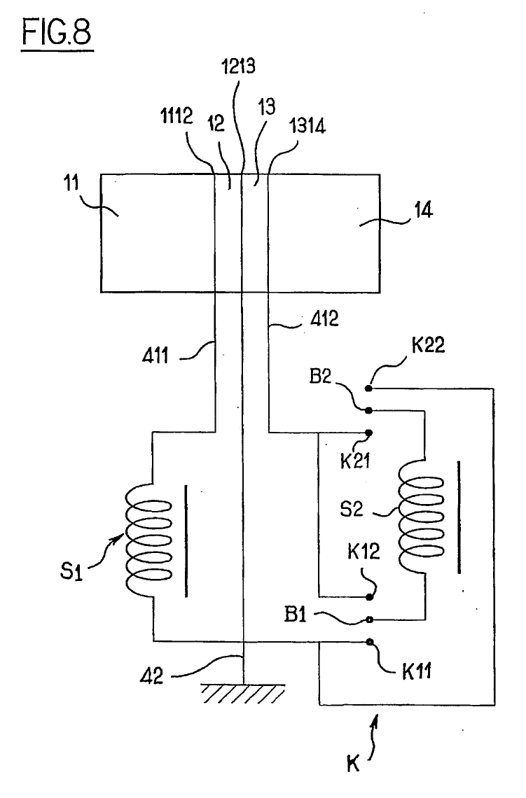

FIG. 7 is a plan view of the wafers and counter-weights of the motor in FIG. 6; and

FIG. 8 is a diagram for a second possible type of single-phase power supply for a motor according to the invention, such second type allowing for two directions of rotation for the motor to be obtained.

FIG. 1 shows a single-phase mode rotation piezoelectric rotary motor 1 powered by a single-phase power supply 40. This motor is also described with reference to FIGS. 3 and 4. The motor comprises a stator 10 and a rotor 20 mounted on a shaft 2. The shaft 2 is fixed rigidly to a frame 3 of the motor 1. The stator 10 is mounted on the shaft 2 in such a way that it cannot rotate around the shaft 2. The rotor 20 is mounted rotating freely around the shaft 2. The rotor may be designed to drive a mechanism, not shown. The stator 10 and the rotor 20 are generally cylindrical in shape.

When idle, the shaft 2 is generally cylindrical in shape and extends, around a central fibre supported by an axis X, along a principal direction D from a fixing 6 of the shaft to the frame. The axis X is an axis of rotation for the stator 20. In FIG. 1, the motor 1 is shown in operation, that is, in its section supporting the stator, the shaft 2 is bent so that its central fibre is supported in this section by a curved line L. Hereafter, the term axial will be used to denote anything that comprises or is parallel to the axis X, and more generally to the central fibre, and the term radial will be used to denote anything that is perpendicular to the axis X, and respectively to the central fibre.

The motor 1 comprises in succession, mounted on and coaxially to the shaft 2, a fixed stop 31, a helical compression spring 32, mounted between the fixed stop 31 and a ball stop 33, the ball stop 33, the rotor 20, the stator 10 and a nut 34 screwed to a free end 36 of the shaft 2.

The nut 34 is used to adjust the length of the spring 32, and therefore to adjust an axial compressive force, known as the pressing force, between the spring and the nut, particularly to compress the rotor 20 on the stator 10. As on known piezoelectric motors, this force is necessary for the rotor 20 to be driven by the stator 10. This force is advantageous because when the motor is idle, that is, when it is not powered, the rotor is thus held immobile relative to the stator. For example, if the motor is used to adjust a mechanism, this adjustment is maintained without there being any need to power the motor.

The stator 10 itself comprises in succession, mounted on and coaxially to the shaft 2, a first counter-weight 11, a first piezoelectric ceramic wafer 12, a second piezoelectric ceramic wafer 13 and a second counter-weight 14. The counter-weights 11, 14 and the wafers 12, 13 are cylinders each comprising two opposite surfaces perpendicular to the direction D when the motor is idle. The term rear surface is used to denote the first surface encountered moving along the shaft in the direction D, and the term front surface is used to denote the second surface encountered in the same direction.

An assembly 11-14 formed by the counter-weights and the wafers is designed to deform under the influence of the power supply 40, so that a travelling wave forms on the rear surface 111 of the first counter-weight 11. The operation of the assembly 11-14 will be explained later on in this description. The travelling wave forming on the rear surface 111 of the first counter-weight 11 drives the rotor rotatably.

In FIG. 1, the rotor is shown in a cylindrical form. It comprises a front surface 22 designed to be in contact with the rear surface 111 of the first counter-weight 11. This front surface 22 of the rotor 20 is covered in a friction layer 23 to ensure that the rotor 20 is driven by the stator 10 without slipping. A rear surface 21 of the rotor 20 acts as a support for the ball stop 33. A bearing, not shown, possibly fitted with a ball bearing, allows for the shaft 2 to be rotatably uncoupled from the rotor 20.

The power supply 40 allows for driving force to be supplied to the motor. This power supply is single-phase, made up of a phase 41 and an earth 42. A first interface 1112 between the front surface 112 of the first counter-weight 11 and the rear surface 121 of the first wafer 12 is connected to the earth 42. A second interface 1213 between the front surface 122 of the first wafer 12 and the rear surface 131 of the second wafer 13 is connected to the phase 41. A third interface 1314 between the front surface 132 of the second wafer 13 and the rear surface 141 of the second counter-weight 14 is also connected to the earth 42. A variable voltage 43 is applied to the phase 41.

The first and second piezoelectric wafers deform under the influence of the axial electric fields between the interfaces, created by the voltage 43 to generate the travelling wave.

A possible power supply 40 for the motor 1 is shown schematically in FIG. 2. It is similar to a forward type switching power supply from which the secondary diodes have been removed. It is controlled by a switch 46 to start and stop the motor. This power supply comprises a transformer 44. This transformer is used to adapt the voltage level to the level of the motor and to provide galvanic isolation. The secondary 47 of the transformer 44 comprises an inductive resistor 48 allowing for the resonance to be obtained by adjusting the frequency of the voltage 43 at the terminals 41, 42 of the motor 1 in accordance with the capacitance of the wafers 12, 13.

The operation of the stator 10 will now be explained with reference to FIGS. 3, 4, and 5. Firstly, the respective shapes and relative arrangements of the wafers 12, 13 and counter-weights 11, 14 will be examined.

The counter-weights and the wafers have approximately the same outer diameter and all four have at their centre an axial hole 51 through which the shaft 2 passes.

The counter-weights 11, 14 are identical to each other. They also comprise singularities made up of two recesses, bores 52, parallel to the axial hole 51 and diametrically symmetrical to each other relative to the axis X. These bores form a geometric dissymmetry around the axis X. These bores define an axial plane P1, P2 for each of the wafers. Thus, for a first axial plane P1 cutting the two bores 52 in the first counter-weight 11 diametrically, priority is given to the bending of the first counter-weight in a mode M1 perpendicular to the first axial plane P1. Similarly, for a second axial plane P2 orthogonal to a plane cutting the two bores 52 in the second counter-weight 14 diametrically, priority is given to the bending of the stator in a mode M2 perpendicular to the second axial plane P2. The bending modes M1, M2 are characteristic of the resonance dissymmetry.

The piezoelectric wafers 12, 13 are identical. They are made up of a first sector 123, 133 and a second sector 124, 134 with opposite axial polarities shown in FIGS. 1 and 3 by arrows marked P+ in the principal direction D and P− in the opposite direction. In FIG. 4, the components are shown in plan view in the direction D. Here, the P+ polarities are shown by circles containing a cross and the P− polarities by circles containing a dot. For the first wafer 12 the first sector 123 is separated from the second sector 124 by a first median axial plane PM1. For the first wafer 13 the first sector 133 is separated from the second sector 134 by a second median axial plane PM2. It must be noted that opposite axial polarities is given to mean polarities such that under the effect of the same voltage, if the axial dimension of a sector decreases, the axial dimension of a sector with opposite polarity increases.

In the example in FIGS. 1, 3 and 4 the wafers are arranged so that the two median planes are perpendicular to each other. That is, one sector of one of the wafers is facing both a sector with the same polarity as it and a sector with opposite polarity on the other wafer. The counter-weights 11, 14 are arranged on either side of the wafers so that the first axial plane P1 is merged with the first median plane PM1 and the second axial plane is merged with the second median plane PM2.

FIG. 5 shows, as a function of the frequency F of the supply voltage:
the amplitudes A of the deformations of the wafers in the two bending modes;
the amplitudes B of the deformations, that is, of the travelling wave on the rear surface 111 of the first counter-weight 11, in the two bending modes; and
the phase difference D between the two bending modes of the deformations on the rear surface of the first counter-weight 11.

It will be noted that for the first bending mode M1 resonance is reached for a frequency F1 and that for the second bending mode M2 resonance is reached for a frequency F2. For a median frequency Fu such that Fu=(F1+F2)/2, the phase difference between the two bending modes is 90° C. The median frequency Fu is the usage frequency for optimum operation of the motor 1.

When the supply voltage varies, the piezoelectric materials forming the wafers deform to a greater or lesser extent depending on whether the electric field created by the voltage is more or less intense, so that the stator bends along the line L.

As the voltage is variable, the electric field varies depending on the voltage. Thus, the axial deformations of the piezoelectric ceramics forming each sector 123, 124, 133, 134 follow, depending on their polarity, the variations in intensity of the axial electric field to which they are subjected. Thus, when the intensity of the electric field increases, the thickness of one sector of a wafer whilst the thickness of the other sector of the same wafer decreases, and reciprocally when the intensity of the electric field decreases. When the intensity of the voltage, and therefore of the fields, varies, the thicknesses also vary progressively, exciting progressively each of the bending modes M1, M2 so that each point on the line L describes around the axis X a path shown approximately as a circle in FIG. 1 by the arrow R.

FIGS. 6 and 7 are views, similar to those in FIGS. 3 and 4 respectively, of a second possible embodiment of a motor according to the invention, and particularly of the arrangement of the components 11-14 of the stator 10. The components are identical to those described with reference to FIGS. 3 and 4, and only their arrangement has changed.

In the example in FIG. 6, the median planes PM1 and PM2 are merged, but form a 180° angle to each other, that is, the wafers 12, 13 are arranged so that a sector with one polarity on one wafer is opposite a sector with the opposite polarity on the other wafer. The counter-weights 11, 14 are arranged so that the axial planes P1, P2 are merged and form a 45° angle to the median planes PM1, PM2.

For the correct operation of the motor, it must be ensured that the rotor 20 rotates approximately in a plane perpendicular to the axis X, that is, that the rotor 20, held firmly against the stator 10 by a pressing force from the spring 32, is not caused to bend by the movements of the stator. To this end, the rotor 20 must have sufficient inertia, and the pressing force exerted must be sufficient for the rotor to be driven rotatably by the stator without such force being too great.

FIG. 8 shows a second possible type of single-phase power supply for a motor according to the invention, suitable for the motor in FIG. 3. This second type allows for the motor to be run as desired in a first direction of rotation or in a second direction of rotation opposite to the first. In FIG. 8, the second interface is connected to the earth 42 and the power supply comprises a transformer on which the primary, powered by a single phase 41, is not shown. This transformer comprises two identical secondaries, the first of which S1 is connected by one of its two terminals to the earth 42 and by the other to the first interface 1112, to which it is used to apply a phase 411. The second secondary S2 comprises two terminals B1, B2 and is controlled by an inverter K. The inverter K comprises two earth contacts K11, K12 connected to the earth 42 and two phase contacts K21, K22, connected to the third interface 1314.

The inverter comprises two positions. In its first position, the first earth contact K11 is in contact with the first terminal B1 and the first phase contact K21 is in contact with the second terminal B2 so that the second secondary is powered identically to the first secondary. Thus, an identical voltage 411, 412 is applied to the first and third interfaces, allowing for the motor to be driven in a first direction of rotation.

In the second position of the inverter K, the second earth contact K12 is in contact with the second terminal B2 and the second phase contact K22 is in contact with the first terminal B2 so that the second secondary is powered in the opposite way to the first secondary. Thus, a voltage 412 with the same amplitude but of opposite sign to the voltage 411 applied to the first interface is applied to the third interface, allowing for the motor to be driven in the second direction of rotation.

Of course, the invention is not limited to the examples that have just been described and a number of adjustments can be made to these examples without leaving the scope of the invention.

Thus, the power supply can be inverted and the earth connected to the second interface whilst the phase is connected to the first and third interfaces.

The shape of the components of the motor is not necessarily cylindrical. Rather than making bores in the counter-weights, it is possible to give different shapes to the counter-weights. Thus, a counter-weight in the shape of a beam will have a different resonance frequency depending on whether the bending is carried out along a small or large edge of the beam. The dissymmetry can also be achieved by the introduction of one or more singularities on one of the counter-weights only or on a part of the stator. The dissymmetry can also be obtained through the use of anisotropic materials, as anisotropy introduces singularities locally. Similarly, the number of wafers is not limited to two.

The stator may also comprise a mechanical amplifier, forming a crosspiece between the assembly and the rotor. It is then used to amplify the travelling wave and drive the rotor rotatably. The amplifier may also be generally cylindrical in shape, and comprise a front surface applied to the rear surface of the first counter-weight and a rear surface in contact with the stator. The travelling wave, amplified on the rear surface of the amplifier, drives the rotor rotatably.

Instead of introducing resonance dissymmetry using geometric dissymmetry in the stator, for example bores in the counter-weights, it can also be introduced using geometric dissymmetry in the fixing of the stator to the frame, that is, for example, in the fixing of the stator to the shaft. Thus, by fixing the stator dissymmetrically, for example in a radial direction and not a perpendicular radial direction, different resonance frequencies are obtained depending on the direction. This solution is of particular interest for very small motors according to the invention.

Of course, the same operating principle can be obtained with other types of electroactive material.

Motors according to the invention have economic and reliability advantages, essentially for motors that only require one direction of rotation. They are particularly suited for small motors such as motors for clock and watch-making, microsurgery and microelectronics.

1. Mode rotation piezoelectric motor (1) comprising a stator (10) fixed to a frame (3) of the motor and designed to bend perpendicular to a principal direction (D), said stator comprising electroactive components (12, 13) stacked in said principal direction, surrounded by two counter-weights (11, 14), characterised in that said stator (10) has geometric dissymmetry (52) in order to create resonance dissymmetry.

2. Motor according to claim 1, characterised in that the electroactive components are piezoelectric ceramics.

3. Motor according to claim 1, characterised in that the geometric dissymmetry is obtained by means of a dissymmetrical method of fixing the stator to the frame.

4. Motor according to claim 1, characterised in that the geometric dissymmetry is obtained by means of the use of anisotropic materials for the stator.

5. Motor according to claim 1, characterised in that the geometric dissymmetry is obtained by means of a dissymmetrical shape (52) of the stator, and particularly a dissymmetrical shape of the counter-weights.

6. Motor according to claim 5, characterised in that the stator comprises piezoelectric ceramics in the form of wafers, the wafers and counter-weights being approximately cylindrical in shape and coaxial to a shaft (2) connecting the stator to the frame (3), said counter-weights comprising recesses on either side of the shaft (52).

7. Motor according to claim 5, characterised in that the stator comprises counter-weights that are approximately identical in shape to each other, so that for two respective axial planes (P1, P2) defined so that a first axial plane P1 for a first counter-weight (11) represents on the second counterweight (12) a plane orthogonal to the second axial plane P2 for said second counter-weight (12), the two axial planes (P1, P2) form a non-zero angle to each other on the stator.

8. Motor according to claim 5, characterised in that each wafer (12, 13) comprises around an axis of rotation of the rotor 20, sectors of piezoelectric material (123, 124, 133, 134) with alternate axial polarity (P+, P−), arranged so that each of the sectors on a first wafer is at least partly opposite a sector with the opposite polarity on another wafer.

9. Motor according to claim 7, characterised in that the two axial planes (P1, P2) form an angle approximately equal to 90°.

10. Motor according to claim 9, characterised in that the stator comprises wafers that are approximately identical in shape to each other, so that for two respective median planes (PM1, PM2) defined identically for each of the wafers independently, the two median planes form a 90° angle to each other, and a first (P1) of the axial planes (P1, P2) of the counter-weights is co-planar with a first (PM1) of the median planes, and respectively, a second (P2) of the axial planes is co-planar with a second (PM2) of the median planes.

11. Motor according to claim 9, characterised in that the stator comprises wafers that are approximately identical in shape to each other, so that for two respective median planes (PM1, PM2) defined identically for each of the wafers independently, the two planes form a 180° angle to each other and the axial planes (P1, P2) form a 45° angle to the median planes.

12. Motor according to claim 6, characterised in that it comprises a single-phase power supply (40) that comprises an earth (42) and a phase (41), so that the phase is connected to an interface (1213) between two wafers and the earth is connected to surfaces (112, 141) of said wafers respectively opposite the said interface (1213), or so that the earth is connected to an interface (1213) between two wafers and the phase is connected to surfaces (121, 132) of said wafers respectively opposite said interface (1213).

13. Motor according to claim 10, characterised in that it comprises a single-phase power supply (40) that comprises an earth (42) connected to an interface (1213) between two wafers (12, 13) and a phase (41) powering a primary of a transformer, said transformer comprising two identical secondaries (S1, S2), a first (S1) of which is connected between the earth and a surface (121) of one of the wafers (12), opposite the interface (1213), to supply to it a first phase 411, and the other secondary (S2) is connected by means of an inverter (K) between the earth and a surface (132) of the other of the wafers (13), opposite the interface (1213) to supply it with a second phase (412) equal or opposite to the first phase (411) depending on the position of the inverter.

14. Method of powering a mode rotation piezoelectric motor (1) comprising a stator (10) fixed to a frame (3) of the motor and designed to bend perpendicular to a principal direction (D), said stator comprising piezoelectric ceramics (12, 13) stacked in said principal direction, surrounded by two counter-weights (11, 14), said stator (10) having geometric dissymmetry (52) in order to create resonance dissymmetry, characterised in that a single-phase power supply (40) is used.

15. Method according to claim 14, characterised in that an intermediate usage frequency (Fu) with two respective resonance frequencies (F1, F2) of two bending modes (M1, M2) characteristic of the resonance dissymmetry is used for the power supply (40).

16. Method according to claim 15, characterised in that a power supply frequency is used that is more particularly selected so that the phase difference between the two bending modes is 90°.
